(19) United States
(12) Patent Application Publication
(10) Pub. No.: US 2018/0040003 A1
(43) Pub. Date: Feb. 8, 2018

(54) ENHANCING MEDIA PARTNER METADATA WITH ATTRIBUTION DATA

(71) Applicant: ADOBE SYSTEMS INCORPORATED, San Jose, CA (US)

(72) Inventor: MATTHEW RYAN SCHARF, SAN FRANCISCO, CA (US)

(21) Appl. No.: 15/229,827

(22) Filed: Aug. 5, 2016

(51) Int. Cl. G06Q 30/02; H04L 29/06; H04L 29/08

(52) U.S. Cl. CPC G06Q 30/0201; H04L 67/06; H04L 65/1063

(57) ABSTRACT

Systems and methods provide for delivering a marketer's attribution data to media partners on a per-content impression basis to allow the media partners to make actionable decisions based on how valuable the marketer views the media partners' content impressions. During content impressions, a pixel tag is fired that captures and sends media partner metadata and content impression data for each content impression to an attribution engine. The attribution engine scores each content impression using an attribution model and associates an attribution score with the media partner metadata for each content impression. An attribution file is generated and sent to each media partner. The attribution file for a given media partner includes an attribution score associated with the media partner metadata for each content impression served by that media partner. The attribution file can also include additional data related to each content impression otherwise only available to the marketer.

### BACKGROUND

Marketers often work with a number of different media partners who manage the delivery of the marketers' digital content to users. For instance, a media partner may serve the marketers' content for content impressions on user devices through inventory won on an open exchange. As another example, a media partner may be a publisher who serves the marketers' content as content impressions within the publisher's own webpages or other digital locations.

When a marketer is working with multiple media partners, some or all of the media partners may be serving content impressions to the same users. When multiple media partners serve content impressions to a user who performs a conversion (e.g., purchases a product), the marketer, as well as the media partner, often would like to know the extent to which each media partner's content impression to the user contributed to the conversion. Traditionally, the media partner does not have visibility into how they're performing relative to other media partners with respect to the fact that their media represents only a partial contribution to a user's eventual conversion. Typically, that information is only available to the marketer if the marketer is leveraging multiple media partners in addition to an attribution model including data from all media partner touchpoints allowing for insight into instances of duplicate content impressions served to the same user from many media partners. There are also instances in which only one media partner from the display marketing channel serves a content impression(s) to a user while other contributing touchpoints come from other marketing channels such as paid search, email, etc. In all instances, due to the lack of insight into all other contributing touchpoints, the media partner is often forced to assume 100% contribution to a conversion because of a lack of visibility into the full contribution to the user's eventual conversion form other media partners or marketing channels.

Meanwhile, the marketer can use attribution models that look at the different content impressions provided to a user who has performed a conversion to determine the contribution of each content impression to that conversion. The marketer can then take actions to optimize towards the results from the attribution model. For instance, the marketer can use data from such an attribution model to optimize the delivery of its content to users by reallocating marketing budget among its media partners. For instance, the marketer can reallocate budget towards media partners that are performing best relative to other media partners as indicated by the attribution model used by the marketer. Additionally, or alternatively, the marketer can give direction to its media partners based on data from its attribution models, for instance, to help the media partners narrow in on targeting tactics that perform best at driving a desired user action.

When marketers are informing media partners how to optimize, there is a disconnect between how advanced attribution models are becoming and the information that is given to media partners in order to inform their optimization efforts towards the media tactics and media partner touchpoints that the attribution models are identifying as valuable. As the marketing industry's attribution models become more sophisticated, any advancements towards informing media partners how to optimize is lagging behind. In particular, each media partner's platform is ultimately responsible for informing their optimizations, but each media partner's platform is a different platform than the attribution platform. The data in the attribution platforms used by marketers are inherently different with different data identifiers for unique users, different methods, and disparate data processing capabilities. As a result, media partners are working from different directional data to help inform their optimizations compared to the data and methodology the attribution platform is using. Each media partner is performing its own optimizations from their own platforms but those optimizations are being only directionally informed from another platform that is effectively speaking a different language because the data is only giving them feedback on their contribution to the marketer's business from a directional level. As a result, the media partners are limited in the ways they can apply their own data to increase the contribution to the marketer's business with respect to how the marketer's attribution model determines contribution value.

### SUMMARY

Embodiments of the present invention relate to, among other things, providing attribution data from a marketer's attribution model to media partners on a per-content impression basis in a way that allows the media partners to associate the attribution data from the marketer with data within their own platform. In accordance with some embodiments, during content impressions on a user device, a pixel tag is fired that captures media partner metadata and content impression data and sends the data from the user device to an attribution engine. The media partner metadata can be used to identify other pieces of data within the media partner's datasets. Attribution data is generated for each content impression based on the content impression data, and the attribution data is associated with the media partner metadata for each content impression. An attribution file for a first media partner is generated that includes attribution data associated with media partner metadata for each content impression from the first media partner, and the attribution file is provided to the first media partner.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1A is a block diagram illustrating an exemplary system in accordance with some implementations of the present disclosure;

FIG. 1B is a block diagram illustrating an exemplary system in accordance with some additional implementations of the present disclosure;

FIG. 2 is an exemplary table illustrating media partner metadata being associated with attribution data for content impressions in accordance with some implementations of the present disclosure;

FIG. 3 is a diagram providing an example to illustrate operation of enhancing media partner metadata with attribution data and returning the data to a media partner in accordance with some implementations of the present disclosure;

FIG. 4 is a flow diagram showing a method for enhancing media partner metadata with attribution data and returning the data to a media partner in accordance with some implementations of the present disclosure;

FIG. 5 is a flow diagram showing another method for enhancing media partner metadata with attribution data and returning the data to a media partner in accordance with some implementations of the present disclosure; and

FIG. 6 is a block diagram of an exemplary computing environment suitable for use in implementations of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms are used throughout this description. Definitions of some terms are included below to provide a clearer understanding of the ideas disclosed herein:

The term “content impression” is used herein to refer to delivery of content for display on a user device. Content can be delivered for display within any of a number of different environments within the scope of embodiments herein. For instance, content can be delivered for display: on a webpage, within search results, within a game, within a mobile app, or within a productivity application (e.g., a word processor application), to name a few.

The term “media partner” refers to an entity that accesses and purchases inventory (i.e., content impressions) on behalf of a marketer and manages the marketer's budgets by serving the content to users in accordance with the marketer's goals. Media partners can be, for instance, demand-side platforms that bid on content impressions on the open exchange or publishers providing locations for content.

The term “pixel tag” refers to code that is triggered when associated content is displayed on a user device for a content impression. A pixel tag is configured to capture media partner metadata and content impression data for the content impression.

The term “media partner metadata” refers to metadata from a media partner's platform regarding a content impression served by the media partner. The media partner metadata may be any data the media partner desires to pass to the content server. For instance, the media partner metadata can include information that allows the media partner to identify the particular content impression, such as a content impression identifier used by the media partner for the content impression. This could include, for example, a user identifier, impression identifier, and campaign identifier. The use of delimiters allows for the media partner to identify and pass multiple metadata values or data values associated with each content impression if they choose.

The term “ad tag” refers to HTML code that is provided to a user device for a content impression and acts as a redirect to cause the user device to request content from a content server for the content impression.

The term “attribution data” refers to data provided by an attribution model for a content impression based on the content impression's contribution to a conversion. For example, attribution data can be an attribution score that represents a value of the content impression to a conversion relative to other content impressions associated with the conversion.

Traditional approaches to optimize towards a marketer's attribution model tend to be a combination of two approaches which provide directional guidance to media partners, at best. One approach is for marketers to provide performance guidance to media partners on a regular basis (e.g., weekly). Attribution models provide reporting outputs of how all media assets and marketing channels are performing through the lens of the attribution model. Marketers typically take these reporting outputs and send them along to media partners on a regular basis (e.g., weekly) to show them how the media partners are performing and ask them to perform the best they can. Generally speaking, conversations tend to go like this: “Partner A, you did well last week, so keep doing what you're doing.” “Partner B, you did poorly last week, so do better.” “Partner C, you did ok last week, so keep doing what you're doing.” Then the media partners look at their own data to see what they did the week prior to either do more, do less, or do more of the same. This is a problem because the data available on the marketer side as well as the media partner side is very rich. However, the data between the marketer and media partner is not correlated, and as a result, predictive and media targeting decisions made are at a far more granular level associated with the media partner's data and only directionally influenced by the marketer's data. It results in a guessing game on the media partner end to correlate changes in reported performance with specific optimizations made from their own systems.

A second traditional approach is to place a media partner pixel on the confirmation page associated with the desired conversion that the content is designed to drive. This solves for the typical delay in performance reporting as it provides media partners with real-time data when a conversion has been performed, and the media partner can use that data to inform targeting decisions. The challenge is that this is a standard firing of a pixel and doesn't conditionally fire when the media partner is deemed to get credit for the conversion through the attribution model's lens. The more sophisticated the attribution model, the more likely there's an unreliable relationship between a pixel fire and actual contribution. So the media partners are still working from directional data. For example, to illustrate the directional nature of this, a media partner's pixel might fire 100 times and the media partner knows it previously targeted 50 of the users that converted, so the media partner will assume that it drove 50 conversions, giving itself 100 percent credit for all 50 conversions. However, the marketer's attribution model might only give this media partner credit for 10 conversions, for example. This is because content impressions from other media partners or other marketing channels being measured by the attribution model were allocated some of the credit for those conversions. So the media partner is optimizing directionally and thus wasting media spend.

Embodiments of the present invention address the technical challenge of optimizing media partners' targeting of content to users by providing an approach that allows a marketer to deliver attribution data to the media partners such that the media partners can tie attribution data to individual content impressions in the media partners' own data as well as any associated data within their data warehouses. This allows a media partner to understand the marketer's view of the extent to which individual content impressions from the media partner contributed to a conversion. Generally, media partners send metadata from their own platforms to an attribution engine that returns the metadata back to the media partners scored with how valuable each content impression was to a conversion according to the marketer's attribution model. As such, instead of media partners trying to optimize based on a marketer's general indication of overall performance or the firing of pixels, media partners receive back metadata that originated from their own platform that includes attribution data on a per-impression basis. This provides data to the media partners that allows the media partners to optimize their content targeting more intelligently. It also allows the media partners to make decisions within their own proprietary systems based upon the marketer's unique business and the media partner's relative contribution to the business with respect to all other media activity measured by the marketer within their attribution model. The alternative could be, and often results in media partners managing each marketer's business and marketing spend in a “one size fits all” manner in which they predominately apply only their own proprietary approach to managing each marketer's media spend. But when media partners receive their own data with associated attribution scores that are relevant to the marketer's unique media mix, the media partners can leverage their own proprietary methods knowing that their data has been further enhanced by the marketer. The application of data is only as valuable as the quality and recency and both the quality and recency are being enriched.

More particularly, in accordance with some embodiments, each time a media partner serves a content impression to a user device, the media partner's server sends a pixel tag to the user device. The pixel tag captures content impression data regarding the content impression and media partner metadata for the content impression. Each media partner can select the type of metadata it wishes to include based on what metadata is important to the media partner. Allowing each media partner to decide what media partner metadata to pass to the marketer accommodates the varying systems and different data used by the media partners, and thus does not limit the unique value propositions of each media partner by using a lowest common denominator solution which dictates the same metadata or data values to be passed by each media partner.

In some alternative embodiments, pixel tags are served to a user device from a content server as opposed to a media partner's server. In such embodiments, for a content impression on the user device, media partner metadata is passed to the content server via an ad tag served by the media partner's server. A pixel tag is then served by the media partner server that captures the media partner metadata from the ad tag, as well as content impression data for the content impression. In both embodiments, the attribution platform is receiving the content impression data and associated media partner metadata immediately because the data is being captured in real-time by the attribution platform pixel.

When a pixel tag is launched on a user device, the media partner metadata and content impression data captured by the pixel tag is sent from the user device to an attribution engine. In this manner, the attribution engine receives media partner metadata and content impression data for a number of content impressions on a user device on a per-content impression basis. The content impression data is processed using an attribution model, which provides attribution data for each content impression. The attribution data for a content impression may be, for instance, an attribution score that represents a value of the content impression to a conversion. The attribution data is associated with the media partner metadata for each content impression. An attribution file is generated for a particular media partner that includes media partner metadata associated with attribution data for each content impression served by the media partner. The recording of the data immediately in the attribution platform via the pixel tag removes the need for the attribution platform to ingest a separate data log from another source capturing the same information, such as a third party ad server data log. This provides a unique value proposition for the attribution platform to score the content impressions on a faster timeline compared to ingesting static data files on a recurring and delayed cadence. This solution allows for the attribution dataset to be populated in real-time because it's happening via a pixel tag that returns data directly to the attribution platform. Additionally, the approach records the content impressions, time stamps, media partner metadata, etc. directly into the attribution platform that will ultimately use the data for attribution modeling and generate the attribution scoring output file to be sent back to media partners.

The attribution file is provided to the media partner, who can do many things with the data included in the attribution file. For instance, media partners can use the data for analytics purposes to uncover pockets of inventory, segments, tactics that over index on high or low contribution scores. Media partners can also use the data for BI platform enhancements budget to be specific to each marketer, to enhance their own algorithm used to manage a marketer's adverting budget, to make more informed optimization decisions that contribute to the bottom line of a marketer's business, and/or to optimize to specific product types for a higher return on investment, identify inventory to blacklist and open up more budget for more competitive bidding on inventory identified with higher attribution scores, building look-a-like models from user identifiers from their own data systems with historically higher attribution score indexes, identifying the impact of viewability on attribution score.

Each media partner receives only their metadata back with associated attribution scores knowing that the attribution scores represent their share of contribution considering their content impressions are receiving only a portion of contribution credit. This is done to avoid sharing any proprietary data from one media partner to another. But additional information can be provided without explicitly sharing other media partner data such as the count of other media partners or media channels that also received a portion of the attribution credit which would indicate whether each media partner or channel is experiencing competitive contribution from other marketing spend and content impressions. This could be an indicator of whether or not the media partner should continue bidding on certain inventory sources such as certain web domains or certain users within certain segments based upon the level of competition from other media partners which could be resulting in a higher cost to win the content impressions due to a higher demand for the users.

Viewability data can also be provided back to each media partner associated with each individual content impression record and accompanying media partner metadata. This is data that adds value in a number of ways. To name a few, the associated viewability data with each content impression can aid the media partner in determining the expected rate of viewability for future impressions they choose to serve or bid on informed by how value of each impressions and the attribution scores assigned to each impression. For example, the media partner can use their own metadata to identify which web domains from their own dataset that disproportionately higher attribution scores are tied to. And by also looking at the associated viewability level, the media partner can determine if inventory with higher viewability ranges receive higher attribution scores, which would indicate areas of opportunity to serve more future content impressions. Alternatively, the media partner can identify that content impressions with no viewability (e.g. below the fold media inventory), or low levels of viewability (e.g., 10-20 percent) has a disproportionately lower level of attribution scores. They can then take action to blacklist low viewability inventory sources depending on each media partner's metadata classification of inventory that receives low attribution scores due to viewability on the user's screen.

Another option at the discretion of the marketer is to include not only content impressions with associated attribution scores that were part of successful paths to purchase, but also content impressions that were not part of successful paths to purchase. This allows the media partner to identify associated information in their database about those unsuccessful content impressions to isolate areas of wasteful media spend and unsuccessful targeting.

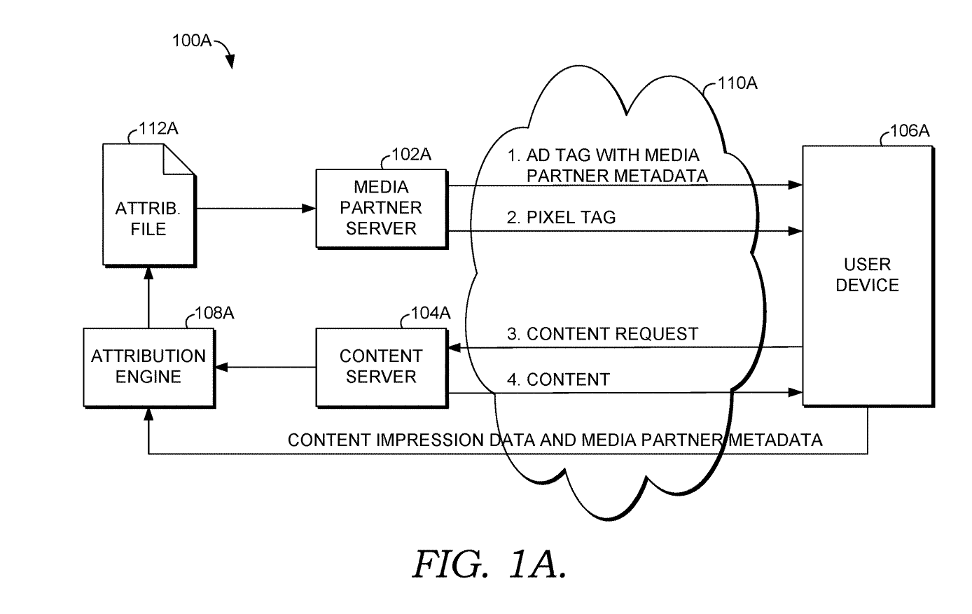

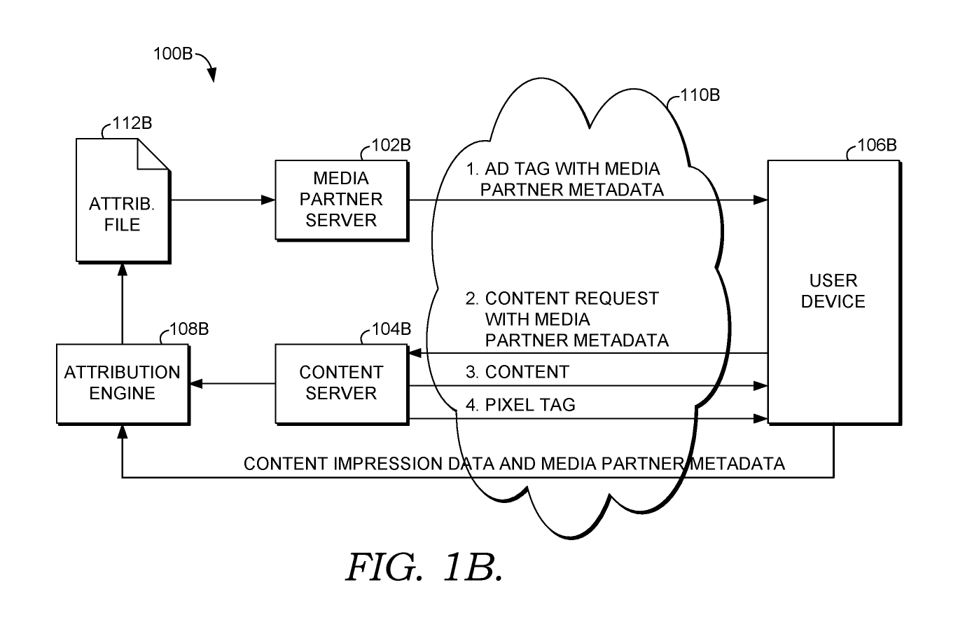

With reference now to the drawings, FIG. 1A is a block diagram illustrating an exemplary system 100 for enhancing media partner metadata with attribution data and returning an attribution file to a media partner that associates the attribution data with the media partner metadata in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

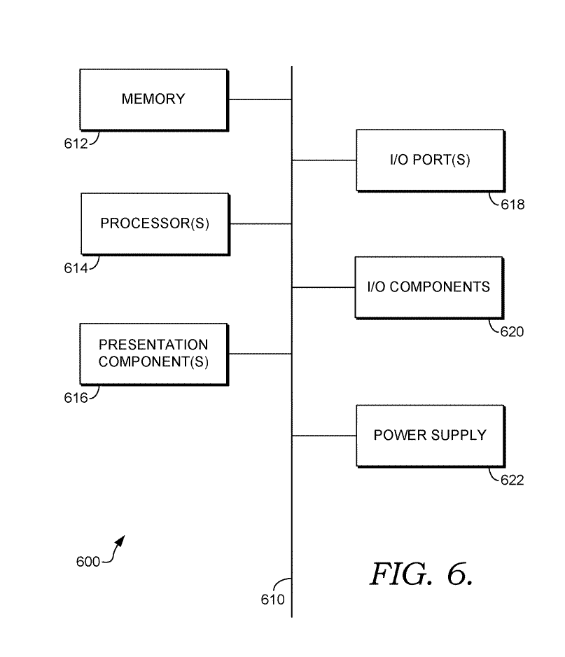

The system 100A is an example of a suitable architecture for implementing certain aspects of the present disclosure. Among other components not shown, the system 100 includes a media partner server 102A, a content server 104A, a user device 106A, and an attribution engine 108A. Each of the components shown in FIG. 1 can be provided on one or more computer devices, such as the computing device 600 of FIG. 6, discussed below. As shown in FIG. 1A, the media partner server 102A and the content server 104A can each communicate with the user device 106A via the network 110A, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100A within the scope of the present invention. Each may comprise a single device or multiple devices cooperating in a distributed environment. Additionally, other components not shown may also be included within the network environment.

The system 100A is generally configured to deliver content for content impressions on user devices, such as the user device 106A, analyze information regarding the content impressions using an attribution model, and provide attribution data to media partners. Generally, when an opportunity for a content impression is available on the user device 106A, the media partner server 102A serves an ad tag to the user device 106A to cause the user device to request content from the content server 104A, which serves content to the user device 106A for the content impression. Additionally, the media partner server 102A serves a pixel tag to the user device 106A for the content impression and populates the pixel tag via macros with media partner metadata. The media partner server 102A may populate the media partner metadata into the pixel tag's variable fields with the use of macros.

In some configurations, the content server 104A is provided by the media partner associated with the media partner server 102A, while in other embodiments, the content server is provided by a third party. In instances in which the content server 104A is provided by third party, the media partner server 102A fires the pixel tag when the media partner server 102A servers the ad tag to the user device 106A in order for the content server to serve the content for the content impression. If content server 104A is provided by the media partner, the media partner server 102A serves the pixel tag when the media partner server 102A serves the media partner's own ad tag in order to serve the content to the user device 106A.

Whether the media partner is serving the content itself or whether it is using a third party ad tag in order to serve the content impression, the media partner server 102A in both cases will fire the pixel tag on the user device 106A (e.g., within a browser) and populate pixel tag with the media partner metadata. By way of example only and not limitation, below is an example of a pixel tag with media partner metadata:

https://www.attributionplatform.com/partnerA={MediaPartnerA_Metadata}.

The media partner metadata included in the pixel tag can be any data the media partner wishes to pass to the attribution engine 108A. This gives the media partners flexibility in terms of what values they want to pass through. The media partners don't have to abide by a lowest common denominator success metric or data identifier that all media partners can use, which could limit each media partner's ability to leverage all proprietary tools and technology at their disposal.

In some instances, the media partner metadata includes information that allows the media partner to identify the particular content impression. For instance, in some configurations, the media partner metadata comprises a content impression identifier used by the media partner for the content impression. As a specific example, the media partner chose to pass three variables: user id, impression, id, and campaign id. These three variables may have been chosen by the media partner, for instance, because they allow the media partner to take meaningful optimization actions when the media partner receives attribution data, as will be discussed in further detail below.

In some configurations, marketers or their media partners can generate pixel tags in a self-serve manner. Each media partner would have at least one pixel tag that is unique to it. For example, if there are three media partners buying media on behalf of the marketer, there would be at least three pixel tags generated from the attribution engine 108A and provided to the media partner for delivery during content impressions—one for each media partner. If the marketer or media partner desired more granular detail to be captured in the attribution model, a unique pixel tag could be generated for each tactic, placement or content size, etc. Alternatively, the media partner can pass that additional information through the pixel tag if desired. For instance, in some configurations, a UI could be provided in which a marketer or media partner of the marketer would generate a pixel tag by entering a few pieces of information such as the number of pixel tags they desire and/or the number of metadata fields it wants to pass into the pixel tag. The pixel tags would be generated according to what was entered.

In addition to dropping a cookie on the user device 106A and capturing the media partner metadata, the pixel tag captures data about the content impression. For instance, this could include information that a typical enterprise level content server would collect in order to generate a log file and generate a record of data in order to use the data for attribution modeling. For example, to name a few, the impression data could include a time stamp of when the pixel tag was fired (which would represent the time of the content impression), the content size (because that could be hard coded into the pixel tag to represent different content sizes), etc.

Content impression data and the media partner metadata for the content impression is passed by the pixel tag to the attribution engine 108A. The attribution engine 108A resides on a computing device accessible over the network 110A and is configured to process content impression data from multiple content impressions on the user device 106A using any known attribution model. Such attribution models are well-known and, as such, will not be described in further detail herein. The attribution model generates attribution data for each content impression. The attribution data generally provides a value of each content impression according to its contribution to a conversion relative to other content impressions that were part of the same path to the conversion. For instance, if five media partners each served two content impressions to a user that led to a conversion by the user, each of those ten content impressions would be scored by the attribution model based on its relative contribution to the conversion.

The media partner metadata is provided to the attribution engine 108A as pass-through metadata, such that the media partner metadata for each conversion is associated with the attribution data determined for the corresponding conversion. The content impressions from the media partner associated with the media partner server 102A are identified, and an attribution file 112A contains data for those content impressions is provided to the media partner. This ensures that the media partner only receives information for its own content impressions and doesn't receive information providing visibility into the relative performance of other media partners. The attribution file 112A at least includes, for each content impression, the media partner metadata passed via the pixel tag for the content impression and attribution data determined for the content impression by the attribution engine 108A. In some instances, the attribution file 112A can include additional information from that marketer that is not otherwise available to the media partner. This may include, for instance, information about the attribution scoring and/or other information that is not related to the attribution scoring. While FIG. 1A shows the attribution file 112A being provided to the media partner server 102A, it should be understood that the attribution file 112A can be provided to the media partner in other manners.

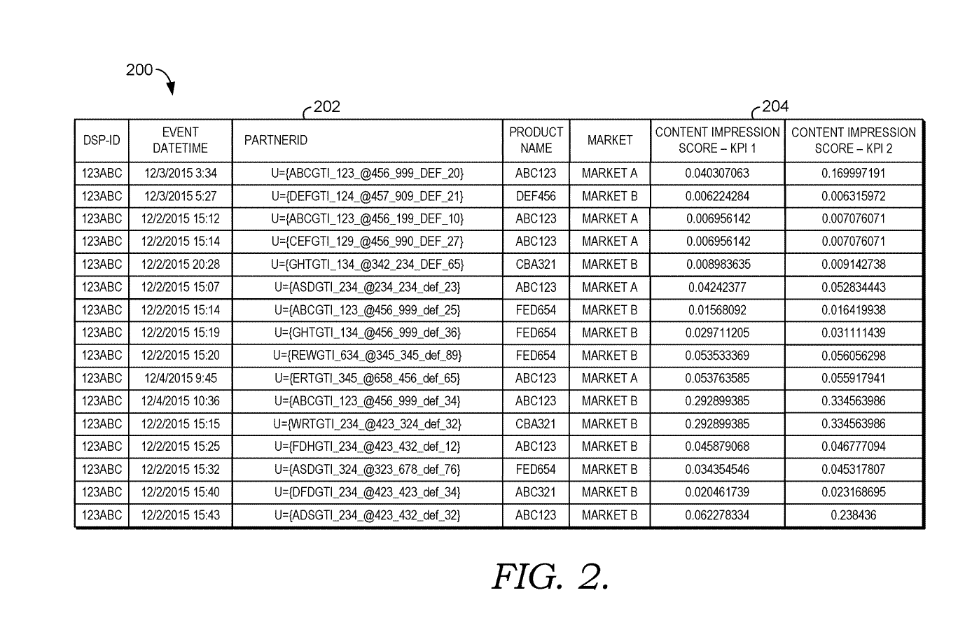

FIG. 2 provides an example of a portion of an attribution file that could be provided to a media partner. The attribution file contains a table 200 in which each row corresponds to a content impression from the media partner. Among other things, the table 200 includes a column 202 that contains the media partner metadata for each content impression and a column 204 that contains attribution data determined for each content impression using an attribution model. As shown in FIG. 2, the table 200 includes columns with additional information about each content impression that may be useful to the media partner. For instance, other information provided could include: the date and time of the content impression, the date and time of an associated conversion, an identification of a product associated with the content impression, viewability exposure duration, percent of content viewable, count of other media partner content impressions or other media channel touchpoints that also received partial attribution credit for a conversion, and content impressions that were not part of successful paths to a conversion and having no associated attribution score.

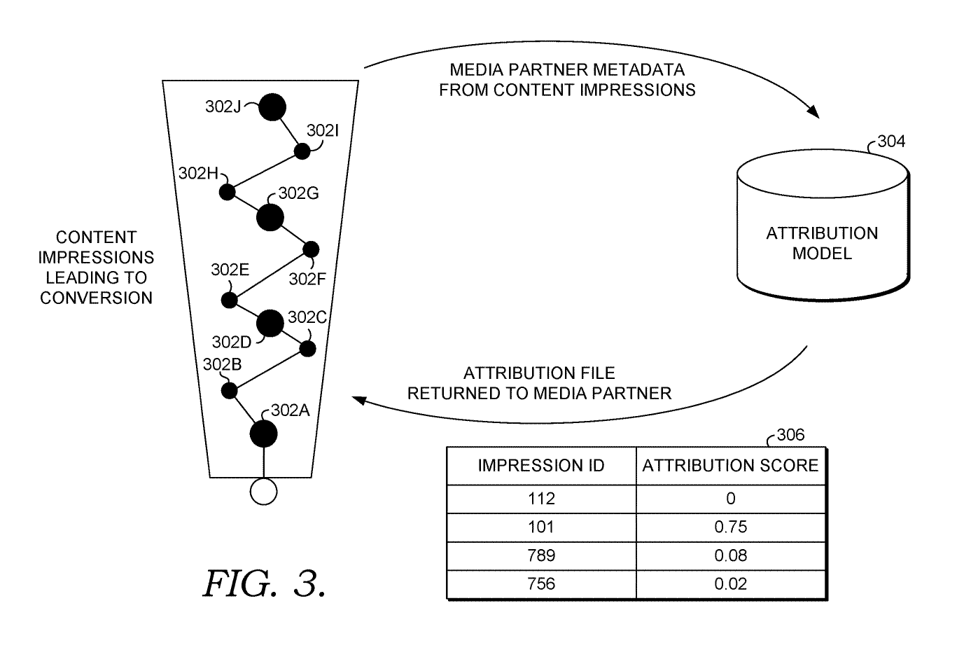

FIG. 3 includes a diagram providing an example to illustrate operation of enhancing media partner metadata with attribution data and returning the data to a media partner. In particular, FIG. 3 shows a number of content impressions 302A-302J provided to a user that are associated with a conversion by that user. The content impressions 302A, 302D, 302G, and 302J are provided by a particular media partner (referred to herein as media partner A), while the remaining content impressions are provided by one or more other media partners. When each content impression is served, content impression data and media partner metadata is provided via a pixel tag as discussed above, and the media partner metadata for each content impression is correlated to other information tracked for each content impression. In the current example, the media partner metadata provided for each content impression from the media partner A is an impression identifier. Data for the content impressions 302A-J (including the media partner metadata) is provided to the attribution model 304, which generates an attribution score for each content impression based on the collection of content impressions 302A-302J that contributed to the conversion. An attribution file 306 for the content impressions 302A, 302D, 302G, and 302J is then returned to the media partner A. The attribution file 306 provided to the media partner A includes the impression identifier and the attribution score for each of the content impressions 302A, 302D, 302G, and 302J. For example, the content impression 302A is identified using the impression identifier “112” and received an attribution score of 0, while the content impression 302D is identified using the impression identifier “101” and received an attribution score of 0.75.

Accordingly, in accordance with embodiments described, media partners receive attribution information that includes the media partner metadata they pass via pixel tags with attribution data for each content impression that were part of successful sequences that ended in a conversion by a user. Media partners can do many things with this attribution information. For instance, the attribution information can be used for analytics purposes to uncover pockets of inventory, segments, tactics that over index on high or low attribution scores. The attribution information can also be used for business intelligence platform enhancements by ingesting the information directly into the media partners' databases since the attribution information includes the media partner metadata which allows the media partners to easily feed the attribution information directly into the media partners' own proprietary data systems so the attribution information can be aligned with other valuable data the media partners use for optimizations. Media partners can use the attribution information to enhance their own algorithms or make tweaks that are specific to managing a marketer's advertising budget by including the attribution information for additional data inputs to enhance what the media partners think is valuable or not in their own algorithms. Media partners can thus make more informed optimization decisions that contribute to the bottom line for marketers' business.

In some configurations, the attribution information provided to media partners can be used to optimize to specific product types. In particular, the attribution information can include not only the media partner metadata with associated attribution scores, but also information about what type of product was purchased (or otherwise associated with a different type of conversion). This has value because the media partners can identify content impressions that have a disproportionately higher attribution scores for certain products that have a higher revenue stream for marketers and the media partners can use that information to optimize toward a higher return on investment.

Alternatively, media partners can build look-a-like models against their own datasets because they can identify unique users that have historically received higher attribution scores for the content impressions the users were served. In addition, the marketer can pass net new information to the media partners that the media partners don't already have. These are advancements that go beyond only enhancing media partner metadata with attribution scores and associated product purchase information. For example, the marketers can pass additional information about each content impression and associated metadata with other data such as the viewability of each impression, such as the viewability range (percent of the content in the viewable space of the device screen) and the duration the content was in the viewable space on the screen. The media partner can map back to other data identifiers to effectively append additional rich data to their own data to identify which content impressions and associated metadata are not receiving any scores at all, or disproportionately low scores. If the marketer imposes a rule that leverages data only the marketer has access to that states for example, that any content impressions with viewability lower than “X” will be removed from attribution scoring, the media partners can receive back these scores with an associated ‘0’ value to indicate a missed opportunity and media partners can then quantify the total cost spent on inventory that was removed from attribution consideration due to not meeting the required viewability threshold. These are examples of data that the marketer has that is net new to the media partner and could be provided back to the media partner on a per-content impression basis by associating the marketer data with the media partner metadata.

In further embodiments, media partners pass additional characters or values to the marketer beyond the metadata they choose in order to aid the marketer in time-series analysis. For example, media partners can pass new values or characters that indicate the start of a new tactic being launched in market which provides the marketer with a flag in the data indicating the beginning or end of a tactic launched by the media partner. The ability to do time-series analysis based upon when the additional characters (such as a * or #) show up in the data feed allows for analysis on when incremental spend may have gone into market in order to allow the marketer to determine the diminishing returns curve changing due to incremental budget.

In addition to enhancing media partner metadata with the goal of giving the media partner rich attribution data to optimize towards the most impactful media and targeting tactics, this invention also solves for another problem by giving media partners insight into how the presence of other media partner content impressions may be diluting the value credited to them for certain touches. One challenge is that media partners don't have visibility into the content impression delivery from other media partners tasked with buying inventory on behalf of the marketer. As a result, a single media partner's content impressions to a user might only be at a frequency of 10, but if there are 5 other media partners delivering content impressions to the same user at a frequency of 10 each, the actual frequency of this user is 50 in this example. Assuming this single user converts, and depending on the logic in the attribution model, this could essentially dilute the available credit to be assigned to each media partner and their respective 10 impressions each. To make things worse, it's arguable that multiple impressions served to the same user within a very short duration of time could be deemed as invaluable by an attribution model and thus removed or collapsed. As an example, if half of these 50 content impressions are served in a one minute period of time it could be concluded by the attribution model that these content impressions delivered in a short window of time should be considered as a single impression delivery to avoid incentivizing and over crediting bad content impression delivery. The impact to the media partner is if all 10 of their content impressions get collapsed and considered as a single exposure (which is highly likely in the programmatically-bid inventory space), only one of their impressions is considered to receive attribution credit, but they paid for all of them. This is effectively wasted media spend. But this innovation can provide insight to avoid these instances.

The solution is to pass back additional flags/columns in the data associated with each attribution score that each media partner's content impressions received. As an example, a marketer can pass three columns associated with each row in each media partner's attribution file in addition to the attribution scores. This first column would indicate whether or not each particular content impression and associated attribution score represents a score tied to a cluster of content impressions that was collapsed and considered to be a single content impression exposure to the user. This would inform the media partner that the score they received was lower than it could have been because there were other impressions in the cluster that got collapsed. The second column would include the count of all total impressions including theirs and other media partners in the collapsed cluster. This gives the media partner a sense of how much their attribution score was diluted. The more the count of content impressions in the cluster that was collapsed, the more it would lower the media partners respective score. The third column would indicate what contribution to the collapsed cluster of content impression came from each media partner. For example, in partner A's attribution file, their contribution might be 10% and partner B's file might be 90%. This tells media partner A that they did not contribute too highly the cause of the impression content clustering. Meanwhile partner B would know that 90% of all the collapsed content impressions in the cluster were caused by them.

All this information is in line with each media partner's chosen metadata for each content impression allowing them to make real optimizations based on this information by tying the collapsed content impression data to their proprietary data to identify inventory and other information in their own system that results in these clustering issues—whether 100% caused solely by them or caused by the collective contribution from all partners. Ultimately, this provides the ability to mitigate the impact on wasted media spend by avoiding the contribution to collapsed content impression clusters.

FIG. 1B provides an alternative system 100B for enhancing media partner metadata with attribution data and returning an attribution file to a media partner that associates the attribution data with the media partner metadata in accordance with implementations of the present disclosure. Similar to FIG. 1A, the system 100B includes a media partner server 102B and content server 104B for delivering content to a user device 106B and recording information regarding the content impression for attribution purposes. However, instead of the media partner server 102B serving the pixel tag, the content server 104B serves the pixel tag. For instance, if marketers or the media partners would prefer that the media partner not control the firing of pixel tags, marketers can use the solution of FIG. 1B by allowing third party content servers, such as the content server 104B, to control the firing of the pixel tag. In the system 100B of FIG. 1B, the pixel tag is still fired on the user device 106B in order to capture content impression data and media partner metadata in the pixel tag while also dropping a cookie on the user device 106B. The difference is that the content server 104B controls the firing of the pixel tag, not the media partner server 102B.

Generally, when an opportunity for a content impression is available on the user device 106B, the media partner server 102B serves an ad tag to the user device 106B. The ad tag is HTML code that causes the user device 106B to request content from the content server 104B. Although FIG. 1B shows the ad tag being provided directly from the media partner server 102B to the user device 106B, it should be understood that the ad tag may be provided by or through one or more other devices.

In accordance with embodiments herein, the ad tag is enhanced with media partner metadata from the media partner that is ultimately passed to the attribution engine 108B with other data from the content impression. As noted above, the media partner metadata included in the ad tag can be any data the media partner wishes to pass to the attribution engine 108B. When the ad tag is received at the user device 106B, it acts as a redirect causing the user device 106B to request content from the content server 104B. The content request to the content server 104B contains information from the ad tag, including the media partner metadata. The content server 104B fires the pixel tag and populates the pixel tag with the media partner metadata that was captured in the ad tag.

In some configurations, a macro at the end of the pixel tag is designed to capture the media partner metadata that is originally populated into the ad tag. By way of example to illustrate, below is an example of ad tag with “u” variables that can be populated with media partner metadata:

https://ad.aaaaaaaaaaa.net/ddm/jump/N123ADC.151111.SITEL/B8734111.118112345;abr=!ie4; abr=!ie5;sz=728 ×90;u={userid}_{impressionid}_{campaignid};ord=[timestamp]?

In turn, the macro of “%pu=!” at the end of the pixel tag shown below is designed to capture the media partner metadata populated into the ad tag.

https://www.attributionplatform.com/partnerA=%pu=!;

The pixel tag causes the media partner metadata and content impressions data to be communicated from the user device 106B to the attribution engine 108B. The attribution engine 108B operates in a similar manner to the attribution engine 108A discussed above with reference to FIG. 1A. Generally, the attribution engine 108B receives content impression data from multiple content impressions on the user device 106B. The attribution engine 108B scores each content impression using any of a number of known attribution models. Content impressions from the media partner associated with the media partner server 102B are identified and an attribution file 112B is generated and provided to the media partner.

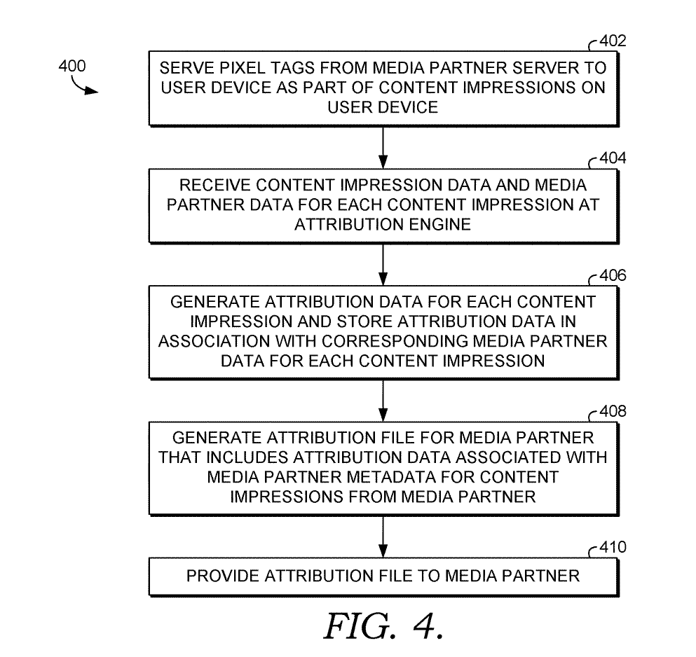

With reference now to FIG. 4, a flow diagram is provided illustrating a method 400 for enhancing media partner metadata with attribution data and returning the data to a media partner. Each block of the method 400 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 402, one or more media partner servers (such as the media partner server 102A of FIG. 1A) serve pixel tags to a user device as part of content impressions on the user device. Each pixel tag is designed to capture media partner metadata for a corresponding content impression and to record content impression data. The media partner metadata for a given content impression could include information identifying the content impression for the media partner. For instance, the media partner metadata could comprise a user identifier, an impression identifier, and a campaign identifier. It should be understood that these are provided by way of example only and the media partner metadata can include a variety of other data selected by the media partner. The content impression data capture via each pixel tag could include information describing a corresponding content impression, such as, for instance, a time stamp of when the pixel tag was fired (which would represent the time of the content impression), the content size (because that could be hard coded into the pixel tag to represent different content sizes), etc.

In response to the pixel tags firing on the user device for each content impression, media partner metadata and content impression data is provided from the user device to an attribution engine, such as the attribution engine 108A of FIG. 1A, as shown at block 404. As such, the attribution engine receives media partner metadata and content impression data for multiple content impressions in this manner. The attribution engine employs an attribution model to generate attribution data for each content impression and stores the attribution data in associated with the media partner metadata for each content impression, as shown at block 406. The attribution data for a given content impression can include an attribution score representing the value of the content impression to a given conversion. Content impressions from a given media partner are identified, and an attribution file is generated that includes the attribution data associated with the media partner metadata for each identified content impression, as shown at block 408. The attribution file is provided to the media partner, as shown at block 410.

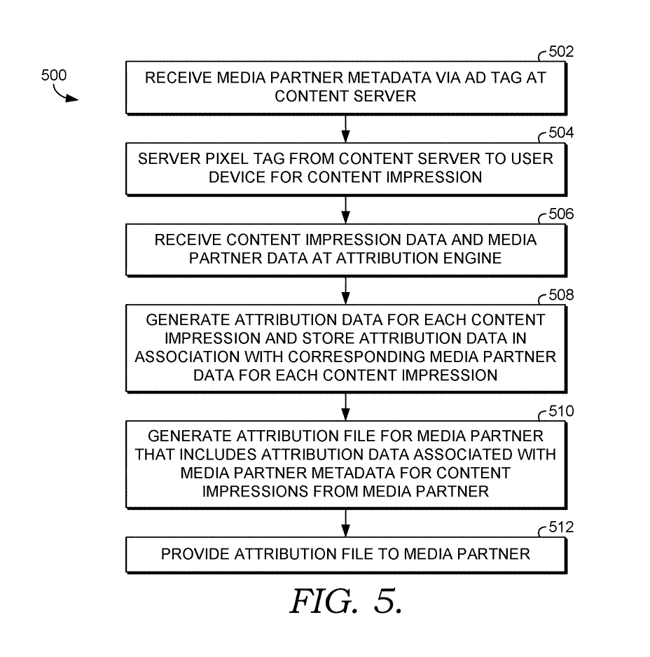

Turning next to FIG. 5, a flow diagram is provided illustrating another method 500 for enhancing media partner metadata with attribution data and returning the data to a media partner. As shown at block 502, a content server (such as the content server 104B of FIG. 1B) receives media partner data for content impression via an ad tag. The ad tag may originate from a media partner server (such as the media partner server 102B of FIG. 1B) and is enhanced to include media partner metadata for the content impression. The media partner metadata for the content impression could include information identifying the content impression for the media partner. For instance, the media partner metadata could comprise a user identifier, an impression identifier, and a campaign identifier. It should be understood that these are provided by way of example only and the media partner metadata can include a variety of other data selected by the media partner.

As shown at block 504, the content server serves a pixel tag to the user device as part of the content impression on the user device. The pixel tag is designed to capture the media partner metadata from the ad tag and to record content impression data. As previously noted, the content impression data could include information describing the content impression, such as, for instance, a time stamp of when the pixel tag was fired (which would represent the time of the content impression), the content size (because that could be hard coded into the pixel tag to represent different content sizes), etc.

In response to the pixel tag firing on the user device, the media partner metadata and content impression data is provided from the user device to an attribution engine, such as the attribution engine 108B of FIG. 1BA, as shown at block 506. The attribution engine receives media partner metadata and content impression data for multiple content impressions in this manner. The attribution engine employs an attribution model to generate attribution data for each content impression and stores the attribution data in associated with the media partner metadata for each content impression, as shown at block 508. The attribution data for a given content impression can include an attribution score representing the value of the content impression to a given conversion. Content impressions from a given media partner are identified, and an attribution file is generated that includes the attribution data associated with the media partner metadata for each identified content impression, as shown at block 510. The attribution file is provided to the media partner, as shown at block 512.

Having described implementations of the present disclosure, an exemplary operating environment in which embodiments of the present invention may be implemented is described below in order to provide a general context for various aspects of the present disclosure. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 600. The computing device 600 may be equipped with depth cameras, such as, stereoscopic camera systems, infrared camera systems, RGB camera systems, and combinations of these for gesture detection and recognition. Additionally, the computing device 600 may be equipped with accelerometers or gyroscopes that enable detection of motion.

As described above, implementations of the present disclosure relate to correlating cost data from a demand-side platform to viewability data from a content server in order to provide cost-per-conversion for different viewability ranges. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when executed by a computing device, cause the computing device to perform operations, the operations comprising:
receiving content impression data and media partner metadata from a user device for each of a plurality of content impressions via pixels tags delivered to the user device by one or more media partner servers;
determining an attribution score for each content impression based at least in part on the content impression data;
associating the attribution score for each content impression with the media partner metadata for each content impression;
generating an attribution file for a first media partner that includes the attribution score associated with the media partner metadata for content impressions from the first media partner; and
providing the attribution file to the first media partner.

2. The one or more computer storage media of claim 1, wherein the media partner metadata for each content impression comprises a value for each of one or more attributes specified by the pixel tag for each content impression.

3. The one or more computer storage media of claim 1, wherein a type of media partner metadata is specified by each of a plurality of media partners.

4. The one or more computer storage media of claim 1, wherein the media partner metadata for the content impressions from the first media partner comprises values for at least one attribute selected from the following: a user identifier, a content impression identifier, and a campaign identifier.

5. The one or more computer storage media of claim 1, wherein the attribution score for a first content impression from the first media partner represents a value of the first content impression for a conversion as determined by an attribution model analyzing a group of content impressions associated with the conversion.

6. The one or more computer storage media of claim 1, wherein the plurality of content impressions are associated with a conversion, and wherein determining the attribution score for each content impression comprises:
identifying, from a larger set of content impressions, the plurality of content impressions as being associated with the conversion;
computing the attribution score for each content impression using an attribution model, the attribution score for each content impression comprising a value of the content impression for the conversion relative to the other content impressions.

7. The one or more computer storage media of claim 1, wherein the attribution file includes additional information for each content impression, the additional information comprises at least one selected from the following: information related to attribution scoring, and information not related to attribution scoring.

8. The one or more computer storage media of claim 7, wherein the additional information for each content impression comprises at least one selected from the following: a date and time of the content impression, a date and time of an associated conversion, an identification of a product associated with the content impression, viewability exposure duration, percent of content viewable, count of other media partner content impressions or other media channel touchpoints that also received partial attribution credit for a conversion, and content impressions that were not part of successful paths to a conversion and having no associated attribution score.

9. The one or more computer storage media of claim 7, wherein the additional information for each content impression comprises at least one selected from the following: information indicating whether the content impression and associated attribution score represents a score tied to a cluster of content impressions that was collapsed and considered to be a single content impression exposure; a total count of content impressions in a collapsed cluster of content impressions; and a contribution to a collapsed cluster of content impression coming from each media partner.

10. A computer-implemented method for associating media partner metadata with attribution data, the method comprising:
receiving content requests for content impressions via ad tags launched at user devices, each content request including media partner metadata from one of a plurality of media partners;
serving pixel tags to the user devices for the content impressions, wherein each pixel tag captures media partner metadata from a corresponding ad tag for a corresponding content impression and also captures content impression data for the corresponding content impression;
generating attribution data for each content impression based on the content impression data for each content impression and storing the attribution data with the media partner metadata for each content impression;
generating an attribution file for a first media partner that includes attribution data associated with media partner metadata for each content impression from the first media partner; and
providing the attribution file to the first media partner.

11. The method of claim 10, wherein the media partner metadata for each content impression comprises a value for each of one or more attributes specified by the ad tag for each content impression.

12. The method of claim 10, wherein the attribution data for a first content impression from the first media partner includes an attribution score that represents a value of the first content impression for a conversion as determined by an attribution model analyzing a group of content impressions associated with the conversion.

13. The method of claim 10, wherein the plurality of content impressions are associated with a conversion, and wherein generating the attribution data for each content impression comprises:
identifying, from a larger set of content impressions, the plurality of content impressions as being associated with the conversion;
computing an attribution score for each content impression using an attribution model, the attribution score for each content impression comprising a value of the content impression for the conversion relative to the other content impressions.

14. The method of claim 10, wherein the attribution file includes additional information for each content impression not otherwise available to the first media partner.

15. The method of claim 14, wherein the additional information for each content impression comprises at least one selected from the following: a date and time of the content impression, a date and time of an associated conversion, and an identification of a product associated with the content impression, viewability exposure duration, percent of content viewable, count of other media partner content impressions or other media channel touchpoints that also received partial attribution credit for a conversion, and content impressions that were not part of successful paths to a conversion and having no associated attribution score.

16. The method of claim 14, wherein the additional information for each content impression comprises at least one selected from the following: information indicating whether the content impression and associated attribution score represents a score tied to a cluster of content impressions that was collapsed and considered to be a single content impression exposure; a total count of content impressions in a collapsed cluster of content impressions; and a contribution to a collapsed cluster of content impression coming from each media partner.

17. A computer system comprising:
a media partner server that serves pixel tags in conjunction with content impressions on user devices, each pixel tag capturing media partner metadata and content impression data for a corresponding content impression; and
an attribution engine configured to determine attribution data for each content impression and associate the attribution data for each content impression with the media partner metadata for each content impression, the attribution engine also configured to generate an attribution file for a first media partner that includes the attribution data associated with the media partner metadata for each content impression from the first media partner.

18. The system of claim 17, wherein the media partner metadata for each content impression comprises a value for each of one or more attributes specified by the pixel tag for each content impression.

19. The system of claim 17, wherein the attribution data for a first content impression from the first media partner includes an attribution score that represents a value of the first content impression for a conversion as determined by an attribution model analyzing a group of content impressions associated with the conversion.

20. The system of claim 17, wherein the attribution file includes additional information for each content impression, wherein the additional information for each content impression comprises at least one selected from the following: a date and time of the content impression, a date and time of an associated conversion, an identification of a product associated with the content impression, viewability exposure duration, percent of content viewable, count of other media partner content impressions or other media channel touchpoints that also received partial attribution credit for a conversion, and content impressions that were not part of successful paths to a conversion and having no associated attribution score.
